(19) United States
(12) Patent Application Publication
(10) Pub. No.: US 2004/0097127 A1
(43) Pub. Date: May 20, 2004

(54) Support for a mobile terminal

(76) Inventors: Simon Smith, Hertford (GB); Matthew Sarkar, Cambridge (GB); Margaret Helen Crosthwaite, Cornwall (GB); Andreas Mehne, Calgary (CA)

Correspondence Address: KNOBBE MARTENS OLSON & BEAR LLP, 2040 MAIN STREET, FOURTEENTH FLOOR, IRVINE, CA, 92614, US

(21) Appl. No.: 10/240,451

(22) PCT Filed: Mar. 30, 2001
(86) PCT No.: PCT/GB01/01453

(30) Foreign Application Priority Data
Mar. 31, 2000 (GB) 0007833.7

(51) Int. Cl. H01R 13/60

(52) U.S. Cl. 439/533

(57) ABSTRACT

A portable support for a mobile terminal, said support comprising: a generally planar base assembly; and a cradle assembly adapted to receive said mobile terminal, said cradle assembly pivotally attached to said base assembly by means of a hinge, wherein said cradle assembly is pivotable, about said hinge, to a first, upright, position with respect to the base assembly, in which the craddle assembly is arranged in a generally upright position when said base assembly is placed on a horizontal surface, wherein said cradle assembly is pivotable, about said hinge, from said first position, to a second, laid-flat, position with respect to the base assembly, in which the cradle assembly is arranged substantially in the same plane as the base assembly, and wherein said support is arranged such that when said cradle assembly is pivoted from said second position to said first position, further pivoting said cradle assembly is prevented when said cradle assembly reaches said first position.

This invention relates to devices for supporting a mobile terminal. More particularly, but not exclusively, the invention relates to a support for making electrical connections for recharging a mobile terminal and/or for making electrical connections for sending data to and receiving data from a mobile terminal.

Devices used for charging mobile terminals and simultaneously coupling the terminal to other data handling apparatus are known in the art. Such a device is described in U.S. Pat. No. 5,052,943. A frame with an open end is adapted to receive the body of a handheld data entry terminal. Mounted on the lowermost walls of this frame is an array of contact elements. These contact elements engage with an array of contact pads mounted to the exterior of the lower wall of the handheld data entry terminal.

U.S. Pat. No. 5,899,421 describes a desk stand for a hand-held computer which allows both variation in the viewing angles of the computer display, and the ability to connect the computer to external, peripheral devices. The stand comprises a heavy gauge wire frame construction which allows the setting of different viewing angles of the computer display. The frame is collapsible. A docking port is mounted to an adaptor plate which hangs from a horizontal member of the frame.

It is an object of the present invention to provide a compact but utile support for a mobile terminal.

It is a further object to provide a support for a mobile terminal which is conveniently transportable.

It is a still further object to provide a support for a mobile terminal which supports the mobile terminal in a generally upright position.

According to one aspect of the present invention there is provided a portable support for a mobile terminal, said support comprising:

a generally planar base assembly; and

a cradle assembly adapted to receive said mobile terminal,

said cradle assembly being pivotally attached to said base assembly by means of a hinge,

wherein said cradle assembly is pivotable, about said hinge, to a first, upright, position with respect to the base assembly, in which the cradle assembly is arranged in a generally upright position when said base assembly is placed on a horizontal surface,

wherein said cradle assembly is pivotable, about said hinge, from said first position, to a second, laid-flat, position with respect to the base assembly, in which the cradle assembly is arranged substantially in the same plane as the base assembly, and

wherein said support is arranged such that when said cradle assembly is pivoted from said second position to said first position, further pivoting said cradle assembly is prevented when said cradle assembly reaches said first position.

In the first position, the cradle assembly is able to support the mobile terminal in a generally upright position. A user can conveniently set the support up in the first position by pivoting the cradle assembly to the point at which the cradle assembly will no longer pivot. After use, the user can conveniently pivot the cradle assembly to the second position, in which the cradle assembly is laid flat, to stow the support for transport. In the laid-flat configuration, the support may adopt a generally planar configuration and may be readily carried in a jacket pocket, a briefcase, or the like.

Preferably, the support comprises an electrical connecting cable running between the cradle assembly and the base assembly for transmitting power to and/or transmitting data to or from said mobile terminal to charging electronics and/or an external electronic device.

According to another aspect of the invention, there is provided a portable support for a mobile terminal, said support comprising:

a generally planar base assembly; and

a cradle assembly adapted to receive said mobile terminal,

wherein said cradle assembly is repositionably connected to said base assembly such that said cradle assembly is locatable in a first, stable, position with respect to said base assembly, in which the cradle assembly is arranged in a generally upright position when said base assembly is placed on a horizontal surface, and a second, laid-flat, position in which the cradle assembly is arranged substantially in the same plane as the base assembly,

wherein said base assembly comprises a first substantially planar surface and a second substantially planar surface opposite said first surface, wherein said support is adapted for said first surface to be placed flat on a horizontal surface in said first position and is adapted for said second surface to be placed flat on a horizontal surface in said second position, when said mobile terminal is held in said cradle assembly.

The base assembly may thus be stably located on a flat, preferably horizontal, surface in two alternative configurations; one in which the first surface is laid onto the flat surface and another in which the second surface is laid onto the flat surface. The support may thus be used in at least two alternative and stably laid configurations when the mobile terminal is held in the cradle assembly.

In accordance with a yet further aspect of the invention, there is provided a portable support for a mobile terminal, said support comprising:

a generally planar base assembly; and

a cradle assembly adapted to receive said mobile terminal,

wherein said cradle assembly is repositionably connected to said base assembly such that said cradle assembly is locatable in a first, stable, position with respect to said base assembly, in which the cradle assembly is arranged in a generally upright position when said base assembly is placed on a horizontal surface, and a second, laid-flat, position in which the cradle assembly is arranged substantially in the same plane as the base assembly,

wherein said base assembly is adapted to present an upper surface serving as a wrist pad for operating said mobile terminal when said mobile terminal is held in said cradle assembly and when said cradle assembly is in said second position and said support is placed on a horizontal surface.

The support may thus be configured to provide a wrist pad, adding to the convenience of use of the mobile terminal, when the support is placed on a horizontal surface.

An embodiment of the invention will now be described, by way of example only, with reference to the accompanying drawings, wherein:

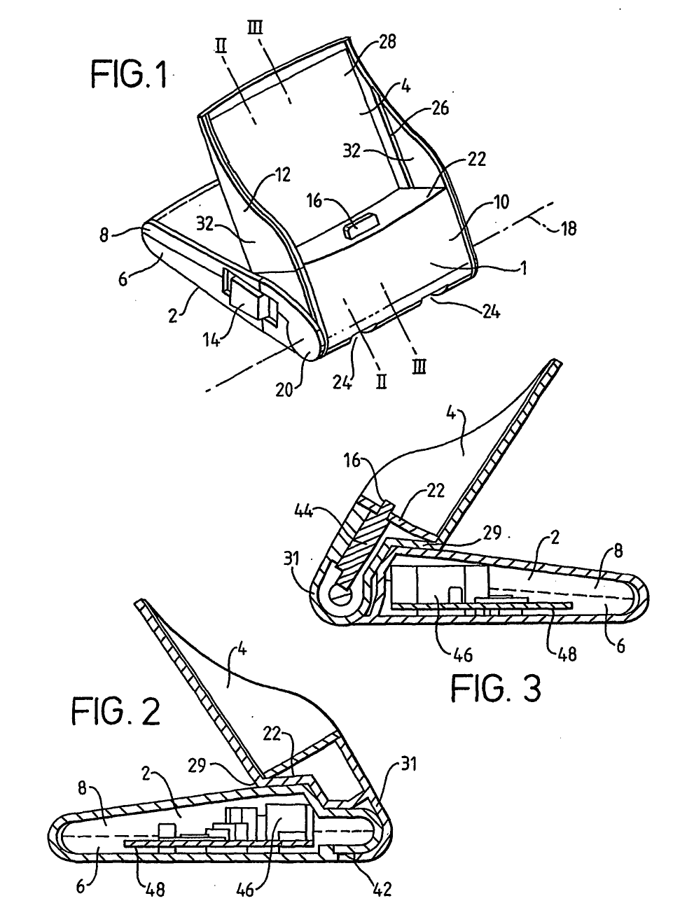

FIG. 1 is a perspective view of a support in a first position according to one embodiment of the present invention;

FIG. 2 is a cross-section taken through II II in FIG. 1;

FIG. 3 is a cross section taken through III III in FIG. 1;

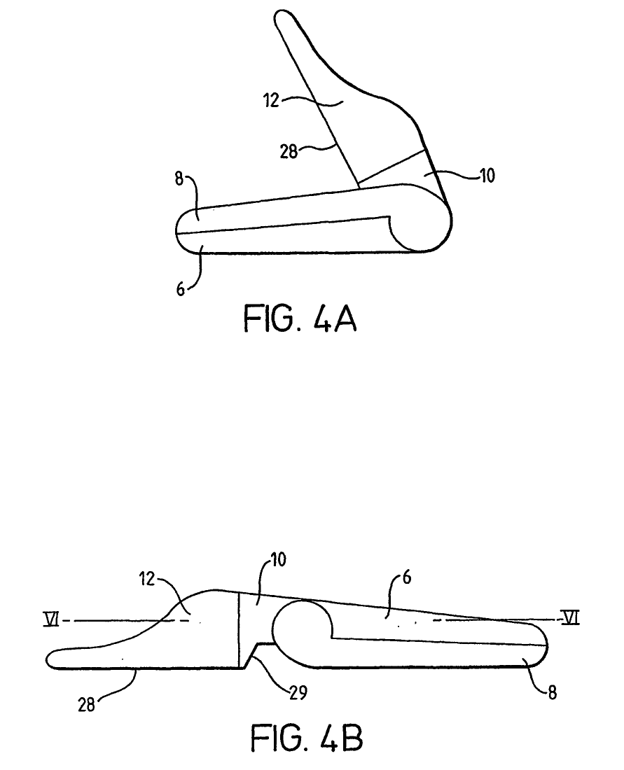

FIG. 4A is a side view of the support in a first position according to one embodiment of the present invention; and

FIG. 4B is a side view of the support shown in FIG. 4A in a second position;

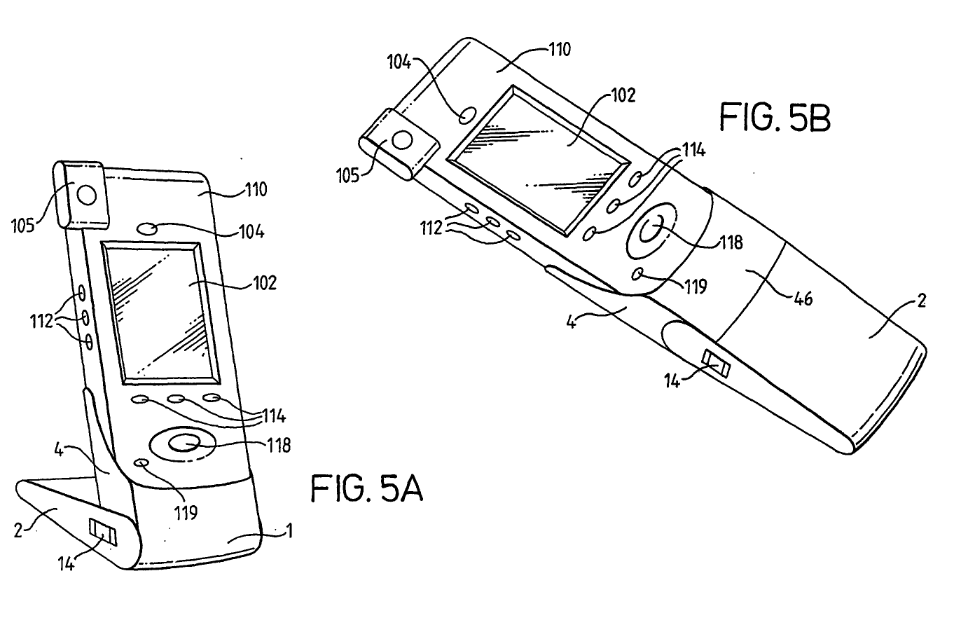

FIG. 5A is a perspective view of the support in a first position holding a videophone according to one embodiment of the present invention;

FIG. 5B is a perspective view of the support of FIG. 5A holding a videophone in a second position;

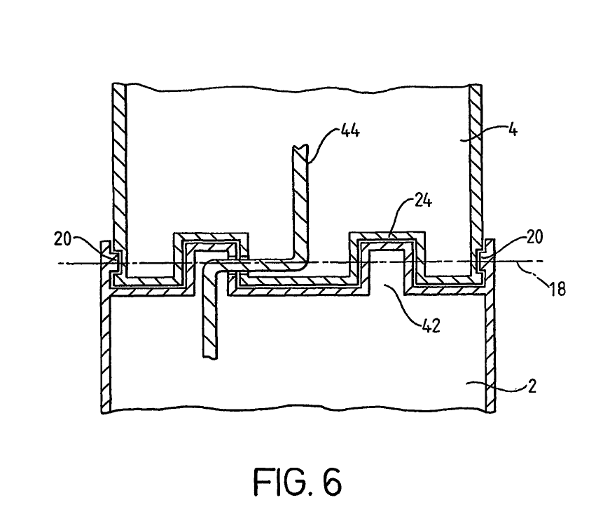

FIG. 6 is a cross-section taken through VI VI in FIG. 4B; and

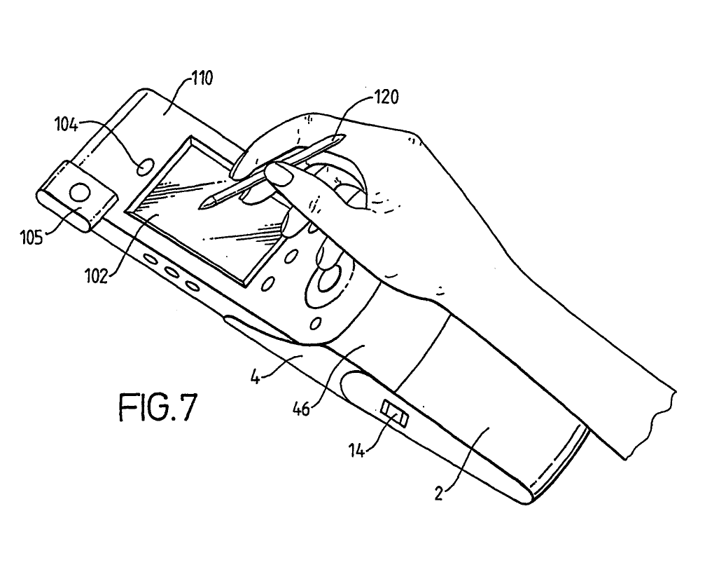

FIG. 7 is a perspective view of the support holding a videophone in a second position when a user is operating the touch-screen display of the videophone.

Referring to FIGS. 1 and 4, the support 1 according to this embodiment of the invention has a generally planar base assembly 2 and a generally planar cradle assembly 4. Each assembly includes an outer moulded plastics shell and the base assembly has electrical components mounted inside and hidden from view therein. Each assembly also includes outer electrical connectors, to be described in further detail below. The base assembly includes a first half shell 6 and a second half shell 8 which when connected together form an enclosure and projecting arms 20 for forming a hinge assembly with the cradle assembly. The cradle assembly includes an upper portion 12, forming a port adapted for receiving the mobile terminal and a lower portion 10, forming an enclosure which is pivotably mounted at its lower end to said base assembly 2 by the hinge assembly.

The upper portion 12 of cradle assembly 4 includes two side walls 32 and a backrest 28. The upper portion 12 of cradle assembly 4 is mounted to lower portion 10 such that the upper surface 22 of lower portion 10 forms a step-shaped landing.

The landing 22 is adapted to receive a mobile terminal such that the back side of the mobile terminal rests against a backrest 28 of the upper portion 12 of the cradle assembly and the bottom of the terminal rests against the landing 22. Projections provided on the sides of the terminal are guided by guide slots 26 into the side portions 32 of the cradle assembly, which also hold the terminal in place thereafter. The cradle assembly 4 further comprises a connection block 16, which is located on the landing 22. The connector 16 extends above the surface of landing 22. When cradle assembly 4 receives a mobile terminal 110, connection block 16 makes plural electrical connections with contact elements of the mobile terminal in order to connect to the charging connection and data connections of the mobile terminal.

Connector 16 is resilient such that it will depress when it is engaged by the corresponding contact elements of the mobile terminal. Connector 16 springs back when the terminal is removed.

The port defined by the upper portion 12 of the cradle assembly is of a drop-in type. Namely, the mobile terminal can be connected to the connector 16 merely by dropping the terminal downwards into the port, and removed therefrom merely by lifting the terminal upwards out of the port.

The hinge assembly between the base assembly and the cradle assembly is formed by arms 20 of the base assembly 2 having cylindrical bosses formed on the inner surface thereof and two corresponding recesses in the side portions of cradle assembly 4. Each recess receives one of the bosses 20 of the base assembly 2. In this way the cradle assembly 4 is pivotably rotatable around a single hinge axis 18 from a first position to a plurality of other positions. In the first position the second portion 8 of the base assembly faces the cradle assembly, and the rear surface of the cradle assembly abuts the base assembly, such that the cradle assembly is not pivotable beyond the first position. A bottom wall 29 of the lower portion 10 of cradle assembly 4 rests against the second portion 8 of the base assembly 2, as can be seen in FIGS. 2 and 3. The angle of inclination between the backrest 28 of the cradle assembly 4 and the supporting surface of the base assembly, when the cradle assembly is in this first position, is about 50°.

A locking mechanism is provided in the location of the hinge to further stabilise the cradle assembly in the first position, such that accidental forward movement to another position is inhibited. The locking mechanism comprises a sprung cantilever, ending with a projection, mounted to the base assembly 2, and a detent in cradle assembly 4, or vice versa. When the cradle assembly 4 is in the first position, the projection on the cantilever releasably engages the opposing detent. The locking mechanism is releasable by forward pressure on the cradle assembly.

In FIG. 4A the support 1 is shown in its first position. In FIG. 4B the support 1 is shown in a second position, where the cradle assembly is pivotably rotated by about 130° with respect to the first position. In this second position the entire support is substantially planar and less bulky for transport.

FIGS. 5A and 5B illustrate the support in the first and second positions, respectively, holding a mobile terminal in use. The mobile terminal in this embodiment is a videophone, generally similar to that described in our International Patent Publication WO 99/59312. The videophone comprises a main housing 110 housing a smart rechargeable lithium ion battery, data processing circuitry, a radio communications unit and various man-machine interface parts. The man-machine interface parts of the terminal include a touch-screen display 102, earpiece 104, button keypad 118 and a microphone aperture 119. The display 102 consists of a TFT LCD covered by a pressure-sensitive membrane, whereby commands and data may be input by a user. To input commands or data, a user manually holds a stylus and applies pressure to a desired part of touch-screen display 102, thus selecting icons displayed on the display 102 and inputting data as desired. The housing includes an audio transmitter, namely a loudspeaker, mounted behind earpiece 104, located at the top of the housing 110, and an audio receiver, namely a microphone, located behind aperture 119 located at the bottom of the housing. Also included are additional function keys 112 and 114 on one side and on the front, respectively. A video and still camera 105 is rotatably mounted to one side of housing 10 at the top thereof, and may be manually redirected by rotational movement about an axis parallel to the top of the terminal.

The mobile terminal is fully operable when held in the support configured in the first and second positions illustrated in FIGS. 5A and 5B, as well as further intermediate positions, in particular those achieved when the support is placed on an uneven surface, or on uneven surfaces. In these intermediate positions the mobile terminal, and cradle assembly, is pivoted away from said second position by less than 90°. For example, the mobile terminal and cradle assembly may be rested against an inclined surface on a desktop, whilst the base assembly is laid flat on the desktop. In the second position, and in intermediate positions in which the cradle assembly is pivoted away from the second position by a small angle, for example less than 10°, the upper surface of the base assembly may serve as a wrist pad 46. The upper surface of the cradle assembly also forms an extension of the wrist pad, and is located parallel to the upper surface of the base assembly when the cradle assembly is in the second position. In this way a user can conveniently operate one or more MMI components while resting his or her lower arm on the wrist pad. This is especially useful for operating the touch-screen display with a stylus 120, as illustrated in FIG. 7.

The base assembly 2 further comprises a connector socket 14. This connector socket 14 is adapted to receive a plug in order to connect the charger to a power supply. The connector socket 14 is connected to charging electronics 46 mounted on a printed circuit board (PCB) 48 which are located in the base assembly 2 of the charger 1. This is illustrated in FIGS. 2 and 3.

The charging electronics include an integrated circuit referred to as a smart battery charger, such as that supplied by Linear Technology, part number LTC 1759 CG. The smart battery charger is mounted on the PCB 48. Control of the charging process is performed by a microprocessor in the smart rechargeable battery communicating via a data bus to the smart battery charger. The smart battery charger is supplied with 12V/2 A power by an external power source, whilst the smart battery charger adjusts the voltage and current supplied to the mobile terminal in accordance with values demanded by the microprocessor of the smart battery.

The support 1 also includes further connectors in the base assembly which may be used to connect the mobile terminal to external devices such as a computer or the like. In this way data and/or images which are received or stored in the mobile terminal can be transmitted to another data handling device. The base assembly is thus provided with an RS232 serial interface and a USB port for data communications between the mobile terminal and external devices. A driver chip for the RS232 serial interface is also mounted on the PCB.

The base assembly 2 comprises two tongues 42, one of which is illustrated in FIG. 2, projecting into the area of the hinge assembly. The cradle assembly has two corresponding recesses 24 which receive the tongues 42 of the base assembly.

Referring now to FIG. 3 and 6, there is an electrical connecting cable 44 connected to the connection block 16 in the cradle assembly 4. Cable 44 carries multiple wires, including separate wires for power supply and data communications. The connecting cable 44 is guided parallel to the rear wall 28 of the cradle assembly 4 and in the centre of lower portion 10 of cradle assembly 4 to the hinge axis 18. The cable is then guided in a 90° turn to follow the hinge axis 18. When the cable reaches recess 24, it is carried over from cradle assembly 4 to base assembly 2, is guided in a further 90° turn and continues in the corresponding tongue 42, which is received in recess 24. The cable 44 is thus guided between the two assemblies parallel to the hinge axis. In this way a twisting force instead of a bending force acts on the cable when the cradle and base assembly are rotated against each other. A twisting movement instead of a bending of the cable helps to preserve the cable and results in a longer lifetime of the cable. Subsequently wires within the cable are guided within the base assembly to their end connections, including the charging electronics and data communications ports.

Whilst in the above-described embodiment cradle assembly 4 is mounted to base assembly 2 by a single hinge and thus cradle assembly 4 is pivotably movable compared to base assembly 2, it is appreciated that other mounting arrangements may be used, whereby cradle assembly 4 is mounted to base assembly 2. Other connecting arrangements, such as a double hinged arrangement and a demountable arrangement would also allow the cradle assembly to be located in first and second positions as described.

The invention is not limited in application to videophones. Aspects of the invention may be implemented in other types of mobile terminals, such as mobile telephone (non-video) handsets, cordless telephone handsets, personal digital assistants (PDAs), etc.

It is to be understood that the embodiments described above are preferred embodiments only. Namely, various features may be omitted, modified or substituted by equivalents without departing from the scope of the present invention, which is defined in the accompanying claims.

1. A portable support for a mobile terminal, said support comprising:
a generally planar base assembly; and
a cradle assembly adapted to receive said mobile terminal,
said cradle assembly being pivotally attached to said base assembly by means of a hinge,
wherein said cradle assembly is pivotable, about said hinge, to a first, upright, position with respect to the base assembly, in which the cradle assembly is arranged in a generally upright position when said base assembly is placed on a horizontal surface,
wherein said cradle assembly is pivotable, about said hinge, from said first position, to a second, laid-flat, position with respect to the base assembly, in which the cradle assembly is arranged substantially in the same plane as the base assembly such that said base assembly and said cradle assembly extend substantially in opposite directions from said hinge, and
wherein said support is arranged such that when said cradle assembly is pivoted from said second position to said first position, further pivoting said cradle assembly is prevented when said cradle assembly reaches said first position.

2. A support according to claim 1, wherein said further pivoting from said second position to a position beyond said first position is prevented by contact of a portion of said cradle assembly with a portion of said base assembly.

3. A support according to claim 1 or 2, wherein said cradle assembly includes an upper end at which a port is provided for receiving said mobile terminal and a lower end at which said hinge is provided.

4. A support according to claim 1, 2 or 3, wherein said cradle includes a backrest against which said mobile terminal is positionable, and wherein the angle of inclination of said backrest with respect to the horizontal when the cradle assembly is in said first position and the base assembly is placed on a horizontal surface is between 30° and 70°.

5. A support according to claim 4, wherein said angle of inclination is approximately 50°.

6. A support according to any preceding claim, wherein said base assembly comprises a first substantially planar surface and a second substantially planar surface opposite said first surface, wherein said support is adapted for said first surface to be placed flat on a horizontal surface in said first position and is adapted for said second surface to be placed flat on a horizontal surface in said second position, when said mobile terminal is held in said cradle assembly.

7. A support according to any preceding claim, wherein said base assembly is adapted to present an upper surface serving as a wrist pad for operating said mobile terminal when said mobile terminal is held in said cradle assembly and when said cradle assembly is in said second position and said support is placed on a horizontal surface.

8. A support according to claim 7, wherein said cradle assembly is adapted to present an upper surface adjacent to the upper surface of the base assembly, said upper surfaces lying in substantially the same plane when said cradle assembly is in said second position.

9. A support according to any preceding claim, wherein said cradle assembly includes a connector for forming an electrical connection with said mobile terminal.

10. A support according to claim 9, wherein said support comprises charging electronics for said mobile terminal.

11. A support according to claim 10, wherein said charging electronics are arranged in said base assembly and said hinge includes an electrical connecting means adapted to form an electrical connection between said charging electronics and said connector.

12. A support according to any of claims 9 to 11, wherein an electrical connecting cable connects said cradle assembly to said base assembly, said cable being arranged partially along the axis of said hinge.

13. A support according to claim 12, wherein one of said base assembly and said cradle assembly has at least one tongue and the other assembly has at least one recess receiving said tongue such that said tongue extends to the axis of said hinge, wherein said electrical connecting cable is transferred from said cradle assembly to said base assembly via said tongue.

14. A support according to any of claims 9 to 13, further comprising a connector in said base assembly for connecting said apparatus to a power source and/or to another data handling apparatus.

15. A support according to any preceding claim, wherein said support comprises means for releasably holding said cradle assembly in said first position.

16. A support according to any preceding claim, wherein said cradle assembly is freely pivotable about said hinge when in said second position, to allow said cradle assembly to readily adopt a position conforming to a non-planar surface on which the support is placed, or to a non-planar recess in which said support is stored for transportation.

17. A portable support for a mobile terminal, said support comprising:
a generally planar base assembly; and
a cradle assembly adapted to receive said mobile terminal,
wherein said cradle assembly is repositionably connected to said base assembly such that said cradle assembly is locatable in a first, stable, position with respect to said base assembly, in which the cradle assembly is arranged in a generally upright position when said base assembly is placed on a horizontal surface, and a second, laid-flat, position in which the cradle assembly is arranged substantially in the same plane as the base assembly,
wherein said base assembly comprises a first substantially planar surface and a second substantially planar surface opposite said first surface, wherein said support is adapted for said first surface to be placed flat on a horizontal surface in said first position and is adapted for said second surface to be placed flat on a horizontal surface in said second position, when said mobile terminal is held in said cradle assembly.

18. A portable support for a mobile terminal, said support comprising:
a generally planar base assembly and
a cradle assembly adapted to receive said mobile terminal,
wherein said cradle assembly is repositionably connected to said base assembly such that said cradle assembly is locatable in a first, stable, position with respect to said base assembly, in which the cradle assembly is arranged in a generally upright position when said base assembly is placed on a horizontal surface, and a second, laid-flat, position in which the cradle assembly is arranged substantially in the same plane as the base assembly,
wherein said base assembly is adapted to present an upper surface serving as a wrist pad for operating said mobile terminal when said mobile terminal is held in said cradle assembly and when said cradle assembly is in said second position and said support is placed on a horizontal surface.

19. An equipment set including a mobile terminal and a support according to any preceding claim, said mobile terminal being adapted to be received in said cradle assembly.

20. An equipment set according to claim 19, wherein said mobile terminal is a mobile telecommunications handset and said port is a drop-in type port for receiving said handset.

21. An equipment set according to claim 19 or 20, wherein said terminal comprises an image pick-up device, said image pick-up device being rotatably mounted on said terminal, to allow said image pick-up device to be directed towards the user when said mobile terminal is held in said cradle assembly, both when said cradle assembly is in said first position and when said cradle assembly is in said second position.

22. An equipment set according to any of claims 19 to 21, wherein said mobile terminal includes a display, said display being oriented in a generally upright position when said terminal is held in said cradle assembly, said cradle assembly is in said first position and said base assembly is placed on a horizontal surface.

23. A portable charger for a mobile terminal, said charger comprising:
a base assembly;
a cradle assembly adapted to receive said mobile terminal;
charging electronics for said mobile terminal, said charging electronics being mounted inside said base assembly and/or said cradle assembly; and
a connecting arrangement whereby said cradle assembly is mounted to said base assembly, said connecting arrangement allowing said cradle assembly to be repositioned between a first position and a second position,
wherein said cradle assembly is in a generally upright position in said first position when said base assembly is placed on a horizontal surface and said cradle assembly is in a lowered position, compared to said upright position, in said second position when said base assembly is placed on a horizontal surface.

24. A portable charger according to claim 23, wherein said charging electronics are mounted inside said base assembly.

25. A portable charger according to claim 24, said cradle assembly comprising a power connector for forming an electrical connection with said mobile terminal, said power connector being connected to said charging electronics via said connecting arrangement.

26. A portable charger according to claim 23, 24 or 25, said base assembly comprising a data transfer port and said cradle assembly comprising a data connector for forming an electrical connection with said mobile terminal, said data connector being connected to said data transfer port via said connecting arrangement.
